(19) United States
(12) Patent Application Publication
(10) Pub. No.: US 2026/0203984 A1
(43) Pub. Date: Jul. 16, 2026

(54) NEURAL SHAPE DEFORMATION TRANSFER

(71) Applicant: DISNEY ENTERPRISES, INC., Burbank, CA (US)

(72) Inventors: Derek Edward BRADLEY, Zürich (CH); Loïc Florian CICCONE, Glattbrugg (CH); Gaspard ZOSS, Zürich (CH); Prashanth CHANDRAN, Zürich (CH)

(21) Appl. No.: 19/019,300

(22) Filed: Jan. 13, 2025

(51) Int. Cl. G06T 13/40; G06T 17/00

(52) U.S. Cl. CPC G06T 13/40; G06T 17/00

(57) ABSTRACT

One embodiment of the present invention sets forth a technique for generating a shape. The technique includes determining (i) a deformed template shape corresponding to a non-neutral expression on a template subject and (ii) a neutral target shape corresponding to a neutral expression on a target subject. The technique also includes generating input representing the deformed template shape and the neutral target shape. The technique further includes generating, via execution of a machine learning model based on the input, a deformed target shape corresponding to the non-neutral expression on the target subject.

### BACKGROUND

### Field of the Various Embodiments

Embodiments of the present disclosure relate generally to machine learning and computer vision and, more specifically, to neural shape deformation transfer.

### Description of the Related Art

Blendshape generation refers to a process of creating a set of blendshapes that include deformations of a “baseline” shape. For example, a set of blendshapes for a face may include different facial expressions made using the face. After the set of blendshapes is created, the blendshapes can be linearly combined via corresponding blendshape coefficients (also known as blendweights) to generate new deformations and/or animations of the face.

Traditionally, blendshape generation typically involves significant time and/or resource overhead. For example, a set of blendshapes for an actor may be generated by scanning the face of the actor using specialized equipment while the actor performs a series of predefined facial expressions. In another example, an artist may use computer-based tools to manually sculpt hundreds of three-dimensional (3D) meshes corresponding to a range of realistic expressions for a virtual character. This set of meshes may be iteratively refined to add detail to and/or adjust the appearance of the virtual character, thereby consuming additional time and resources (e.g., multiple months to a year).

More recently, techniques have been developed to transfer a set of blendshapes corresponding to deformations (e.g., facial expressions) of a “template” subject (e.g., a face with a certain identity) onto a “target” subject (e.g., a face with a different identity). These techniques include geometry-based techniques that transfer vertex displacements and/or triangle deformations computed between a “neutral” shape (e.g., a face with a neutral expression) for the template subject and a deformed shape for the template subject onto the neutral shape of the target subject.

However, these geometry-based approaches do not account for unique deformations of faces (and other shapes) in performing semantically similar expressions. For example, the transfer of deformations from a template face to a target face may fail to reflect differences in the activation of facial muscles by the template face and target face in performing the same facial expression (e.g., a smile). As a result, deformed target shapes generated via transfer of vertex displacements and/or triangle deformations associated with template shapes may include deformations that are specific to template subjects represented by the template shapes and/or lack deformations that are specific to target subjects represented by the target shapes.

The techniques also include data-driven techniques that use a neural network to learn disentangled latent spaces of facial identity and expression from a large database of subjects performing semantically identical expressions. After such latent spaces are learned by the neural network, an identity may be selected by fixing a corresponding point in the latent space of identities, and deformed shapes that correspond to blendshapes for that identity may be generated by decoding discrete points in the latent space of expressions using the neural network.

However, these data-driven approaches are adversely affected by a reliance on a “blendshape basis” that includes a predefined set of blendshapes. More specifically, during training of a neural network to learn disentangled latent spaces for the task of blendshape generation, blendweight vectors that include blendweights representing the strengths of the corresponding blendshapes in the blendshape basis are used as additional input into the neural network. These blendweight vectors are typically obtained by solving a non-convex “rig inversion” optimization problem that produces unique identity-specific blendweights (e.g., as individuals can perform semantically identical expressions in unique ways). These identity-specific blendweights lead to a suboptimal disentanglement of the identity and expression latent spaces and can negatively impact subsequent blendshape generation and/or other downstream tasks. Further, the neural network is limited to the predefined blendshape basis and cannot be used with different numbers of blendshapes and/or changes to the semantic expression represented by the blendshapes without retraining.

As the foregoing illustrates, what is needed in the art are more effective techniques for transferring semantically identical deformations between shapes associated with different identities.

### SUMMARY

One embodiment of the present invention sets forth a technique for generating a shape. The technique includes determining (i) a deformed template shape corresponding to a non-neutral expression on a template subject and (ii) a neutral target shape corresponding to a neutral expression on a target subject. The technique also includes generating input representing the deformed template shape and the neutral target shape. The technique further includes generating, via execution of a machine learning model based on the input, a deformed target shape corresponding to the non-neutral expression on the target subject.

One technical advantage of the disclosed techniques relative to the prior art is the ability to generate blendshapes for a new target subject from an existing set of blendshapes for a template subject. Consequently, the disclosed techniques may consume less time and/or fewer resources than traditional blendshape generation approaches that involve scanning a target subject and/or manually sculpting 3D meshes corresponding to different expressions of the target subject. Another technical advantage of the disclosed techniques is the ability to transfer deformations from the template subject to the target subject without requiring a predefined blendshape basis and/or set of blendweights for the template subject. The disclosed techniques can thus improve the quality of the generated blendshapes over geometry-based techniques that do not account for deformations that are unique to individuals and/or data-driven techniques that train neural networks to generate blendshapes using identity-specific blendweights. The disclosed techniques additionally allow the generated blendshapes to generalize to expressions that are not included in a predefined blendshape basis and/or blendshape systems that include different numbers and/or types of blendshapes without requiring retraining of the machine learning model. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the training engine and execution engine of FIG. 1, according to various embodiments.

FIG. 3 illustrates example training data associated with the machine learning model of FIG. 2, according to various embodiments.

FIG. 4 illustrates example inputs and outputs associated with the machine learning model of FIG. 2, according to various embodiments.

FIG. 5 is a flow diagram of method steps for performing neural shape deformation transfer, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

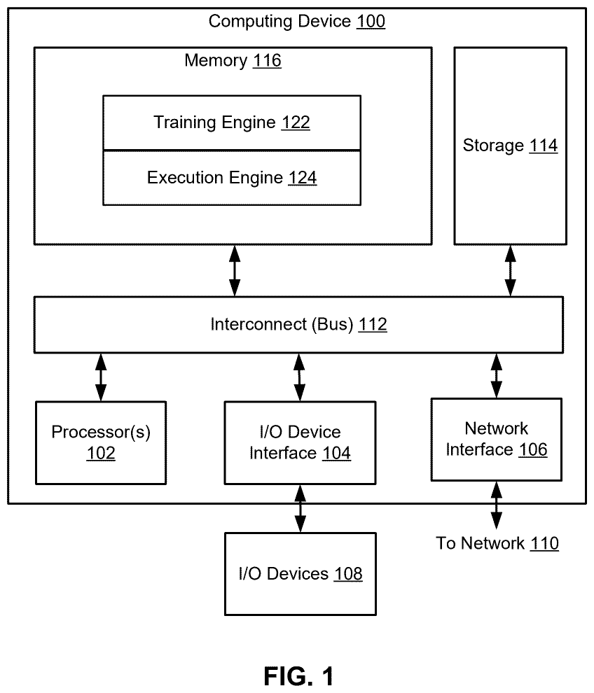

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in memory 116.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and/or execution engine 124 could execute on various sets of hardware, types of devices, or environments to adapt training engine 122 and/or execution engine 124 to different use cases or applications. In a third example, training engine 122 and execution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In one or more embodiments, training engine 122 and execution engine 124 are configured to train and execute a machine learning model to perform neural shape deformation transfer, in which the deformation of a template subject relative to a neutral shape for the same template subject is transferred to a target subject in a manner that is consistent with the identity of the target subject. For example, the machine learning model may be used to transfer deformations associated with a deformed template shape corresponding to a non-neutral expression on a template face (or another type of deformable object associated with a first identity) onto a neutral target shape corresponding to a neutral expression on a target face (or another type of deformable object associated with a second identity). Output of the machine learning model may be used to generate a deformed target shape that includes a facial deformation that is unique to the identity of the target face and semantically matches the non-neutral expression on the template face. Training engine 122 and execution engine 124 are described in further detail below.

### Neural Shape Deformation Transfer

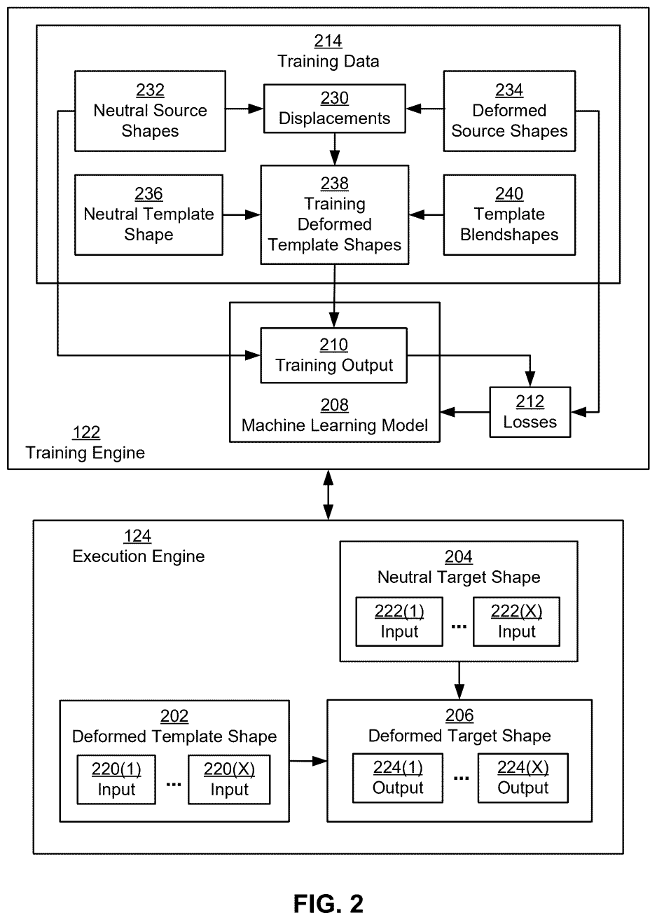

FIG. 2 is a more detailed illustration of training engine 122 and execution engine 124 of FIG. 1, according to various embodiments. As mentioned above, training engine 122 and execution engine 124 operate to train and execute a machine learning model 208 to perform neural shape deformation transfer.

More specifically, training engine 122 and execution engine 124 train and execute machine learning model 208 to transfer deformations associated with a deformed template shape 202 onto a neutral target shape 204 to produce a deformed target shape 206. Deformed template shape 202 may include a non-neutral (e.g., non-resting) expression on a face, body, body part, and/or another type of deformable object corresponding to a template subject (e.g., a subject that acts as a template for deformations to be transferred to other subjects). Neutral target shape 204 may include a neutral (e.g., resting) expression on a target subject (e.g., a subject to which a deformation is to be transferred) that is the same type of deformable object. Deformed target shape 206 may include deformations that semantically match the non-neutral expression in deformed template shape 202 and are consistent with the identity of the target subject. Consequently, deformed template shape 202 is used as a descriptor for the non-neutral expression to be transferred to neutral target shape 204 instead of blendweights associated with a set of blendshapes for the template subject.

For example, deformed template shape 202 may include a mesh, point cloud, and/or another three-dimensional (3D) representation of a first person smiling, frowning, grimacing, smirking, making a face, and/or performing another non-neutral facial expression. Neutral target shape 204 may include a 3D representation of a second person making a neutral (e.g., resting) facial expression. Deformed target shape 206 may include a 3D representation of the second person making the same non-neutral facial expression as the first person in deformed template shape 202.

To allow machine learning model 208 to learn mappings between deformations on the template subject and semantically identical deformations on other subjects, training engine 122 trains machine learning model 208 using training data 214 that includes deformed source shapes 234 for multiple source subjects (e.g., a collection of faces and/or other types of deformable objects with identity-specific deformations to be learned by machine learning model 208) paired with training deformed template shapes 238 for the template subject. Each training deformed template shape includes a non-neutral expression that semantically matches the non-neutral expression of a deformed source shape with which the training deformed template shape is paired.

As shown in FIG. 2, training engine 122 generates training deformed template shapes 238 in training data 214 using deformed source shapes 234, neutral source shapes 232 for the same source subjects, a neutral template shape 236 that includes a neutral expression on the template subject, and/or a set of template blendshapes 240 for the template subject. More specifically, training engine 122 computes displacements 230 of vertices, points, polygons, and/or other positions in each of deformed source shapes 234 and corresponding positions in a neutral source shape (e.g., from the set of neutral source shapes 232) for the same source subject. For example, training engine 122 may compute displacements 230 as differences between 3D coordinates of vertices in deformed source shapes 234 and 3D coordinates of vertices in the corresponding neutral source shapes 232.

Training engine 122 transfers displacements 230 associated with each deformed source shape onto neutral template shape 236 for the template subject to generate an initial deformed template shape for the template subject. For example, training engine 122 may apply, to points, vertices, polygons, and/or other positions in neutral template shape 236, displacements 230 computed between a given deformed source shape and a corresponding neutral source shape to produce an initial deformed template shape. The initial deformed template shape may thus include identity-specific deformations associated with the deformed source shape, as well as geometric artifacts.

To constrain the deformations transferred from the source subject to the identity of the template subject, training engine 122 fits a set of template blendshapes 240 for the template subject to the initial deformed template shape and uses the result as an updated deformed template shape that is included in the set of training deformed template shapes 238. For example, training engine 122 may use a regularized blendshape solver and/or another optimization technique to compute blendweights that, when linearly combined with template blendshapes 240, produce an updated deformed template shape that most closely matches the initial deformed template shape. Training engine 122 may repeat the process for each of deformed source shapes 234 to generate a set of training deformed template shapes 238 that is paired with deformed source shapes 234.

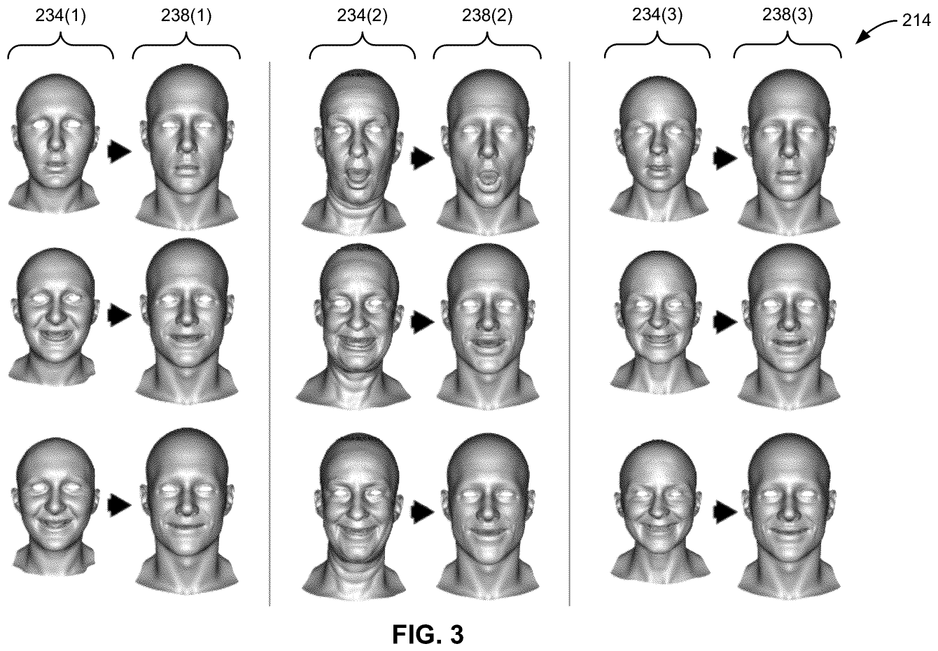

FIG. 3 illustrates example training data 214 associated with machine learning model 208 of FIG. 2, according to various embodiments. As shown in FIG. 3, training data 214 includes three sets of deformed source shapes 234(1)-234(3). Deformed source shapes 234(1) include three different deformations of a source subject associated with a first identity (e.g., the face of a first person), deformed source shapes 234(2) include three different deformations of a source subject associated with a second identity (e.g., the face of a second person), and deformed source shapes 234(3) include three different deformations of a source subject associated with a third identity (e.g., the face of a third person). In other words, each of deformed source shapes 234(1)-234(3) may correspond to a facial expression that is made by one of three people.

Training data 214 also includes three sets of training deformed template shapes 238(1)-238(3). Each set of deformed template shapes 238(1), 238(2), or 238(3) is generated from, and paired with, a corresponding set of deformed source shapes 234(1), 234(2), or 234(3). More specifically, training deformed template shapes 238(1) include three deformed template shapes that are generated from (and paired with) three corresponding shapes in deformed source shapes 234(1), training deformed template shapes 238(2) include three deformed template shapes that are generated from (and paired with) three corresponding shapes in deformed source shapes 234(2), and training deformed template shapes 238(3) include three deformed template shapes that are generated from (and paired with) three corresponding shapes in deformed source shapes 234(3).

Each deformed template shape in training deformed template shapes 238(1)-238(3) includes a deformation of a face corresponding to a template subject that reflects the identity of the template subject and a facial expression that is semantically identical to that of a corresponding deformed source shape. Each deformed template shape may be generated by transferring displacements between the corresponding deformed source shape and a neutral source shape for the same face onto a neutral template shape for the template subject and subsequently matching the result to a linear combination of template blendshapes 240 for the template subject, as discussed above. Thus, training data 214 may include training deformed template shapes 238(1)-238(3) that are consistent with the identity of the template subject and include facial expressions that are semantically identical to those in deformed source shapes 234(1)-234(3).

Returning to the discussion of FIG. 2, training engine 122 trains machine learning model 208 using neutral source shapes 232, deformed source shapes 234, and training deformed template shapes 238. In particular, training engine 122 inputs pairs of neutral source shapes 232 and training deformed template shapes 238 into machine learning model 208. For each inputted pair of a neutral source shape and a training deformed template shape, training engine 122 executes machine learning model 208 to generate training output 210 that includes a prediction of a deformed source shape with the same identity as the neutral source shape and the same expression as the training deformed template shape. Training engine 122 computes one or more losses 212 between this training output 210 and a corresponding “ground truth” deformed source shape from the set of deformed source shapes 234. Training engine 122 additionally updates parameters of machine learning model 208 in a way that reduces these losses 212.

For example, training engine 122 may retrieve, from training data 214, a neutral source shape that includes a neutral facial expression on a face corresponding to a source subject, a deformed source shape that includes a non-neutral expression on the same face, and a training deformed template shape that includes a non-neutral expression on a different face corresponding to the template subject. Training engine 122 may input representations of the neutral source shape and training deformed template shape into machine learning model 208. Training engine 122 may execute machine learning model 208 to convert the input into corresponding training output 210 that represents a prediction of the deformed source shape. Training engine 122 may compute a mean squared error (MSE) and/or another type of loss that measures the difference between representations of vertices and/or other values in training output 210 and corresponding values associated with the deformed source shape. Training engine 122 may repeat the process with additional neutral source shapes 232, deformed source shapes 234, and training deformed template shapes 238 in training data 214. After losses 212 have been computed from a certain number of training examples, training engine 122 may use a training technique (e.g., gradient descent and backpropagation) to train machine learning model 208 based on losses 212. Training engine 122 may continue training machine learning model 208 in this manner until the parameters of machine learning model 208 converge, losses 212 fall below a threshold, and/or another condition indicating that training of machine learning model 208 is complete is met.

While the training of machine learning model 208 has been described above as being performed using training deformed template shapes 238 that are generated based on displacements 230 between neutral source shapes 232 and deformed source shapes 234, neutral template shape 236 for the template subject, and template blendshapes 240 for the same template subject, it will be appreciated that training data 214 may be generated and/or determined using other techniques. For example, a blendshape solver and/or another optimization technique may be used to compute blendweights that, when combined with a set of blendshapes for a given source subject, result in a shape that most closely matches the deformation associated with a corresponding deformed source shape for the same source subject. These blendweights may then be combined with template blendshapes 240 for the template subject to produce a corresponding training deformed template shape with deformations that are semantically identical to those of the deformed source shape. In another example, training data 214 that includes deformed source shapes 234 paired with training deformed template shapes 238 may be generated by matching each deformed source shape corresponding to a given source subject to a semantically identical deformed template shape corresponding to the template subject.

After training of machine learning model 208 is complete, execution engine 124 uses the trained machine learning model 208 to transfer arbitrary deformations associated with a given deformed template shape 202 for the template subject onto neutral target shape 204 for a target subject with a different identity. For example, execution engine 124 may use machine learning model 208 to transfer a non-neutral facial expression on a face corresponding to the template subject, as represented by deformed template shape 202, onto a neutral facial expression on a different face corresponding to the target subject, as represented by neutral target shape 204, resulting in deformed target shape 206 that includes the non-neutral facial expression from deformed template shape 202 and the identity associated with neutral target shape 204.

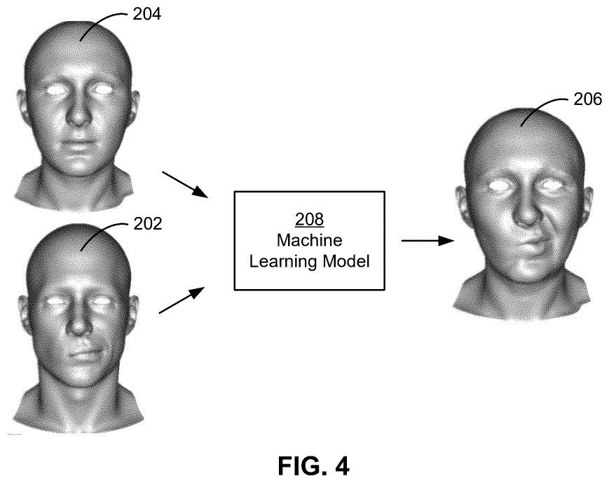

FIG. 4 illustrates example inputs and outputs associated with machine learning model 208 of FIG. 2, according to various embodiments. The inputs include an example deformed template shape 202 and an example neutral target shape 204. Given these inputs, machine learning model 208 generates output that includes an example deformed target shape 206.

As shown in FIG. 4, deformed template shape 202 includes a face with an identity of a template subject (e.g., a first person) and a non-neutral facial expression. Neutral target shape 204 includes a face with an identity of a target subject (e.g., a second person) and a neutral facial expression. Deformed target shape 206 includes the face of the target subject and the non-neutral facial expression of the template subject. Consequently, machine learning model 208 may be used to transfer the non-neutral expression from the face of the template subject to the face of the target subject in a way that preserves the identity and unique facial deformations of the targe subject.

Returning to the discussion of FIG. 2, execution engine 124 determines a set of inputs 220(1)-220(X) (each of which is referred to individually herein as input 220) representing deformed template shape 202. Execution engine 124 also determines another set of inputs 222(1)-222(X) (each of which is referred to individually herein as input 222) representing neutral target shape 204. Execution engine 124 applies machine learning model 208 to inputs 220 and 222 to produce a set of outputs 224(1)-224(X) (each of which is referred to individually herein as output 224) representing deformed target shape 206. After outputs 224 are generated by machine learning model 208, execution engine 124 uses outputs 224 to generate deformed target shape 206.

In one or more embodiments, inputs 220 and 222 and outputs 224 are varied to reflect the type and/or architecture of machine learning model 208, available representations of deformed template shape 202 and neutral target shape 204, desired representations of deformed target shape 206, and/or other factors. For example, machine learning model 208 may include a transformer neural network that includes one or more attention modules. Inputs 220 and 222 into the transformer neural network may include tokens representing arbitrary sets of vertices in deformed template shape 202 and neutral target shape 204, and outputs 224 may include a set of displacements for each token associated with neutral target shape 204. Execution engine 124 may apply the outputted displacements to the corresponding vertices in neutral target shape 204 to generate deformed target shape 206.

In another example, machine learning model 208 may include a DiffusionNet neural network that includes a series of DiffusionNet blocks, where each DiffusionNet block includes a spatial diffusion layer, a set of spatial gradient features, and a per-vertex multilayer perceptron (MLP). Inputs 220 and 222 into the DiffusionNet neural network may include vertices in deformed template shape 202 and neutral target shape 204, as well as precomputed geometric properties (e.g., Laplace matrix, mass matrix, spatial gradient matrix, eigenbasis, etc.) associated with deformed template shape 202 and neutral target shape 204. Given this input, execution engine 124 may use the DiffusionNet neural network to generate outputs 224 that include per-vertex displacements associated with neutral target shape 204. Execution engine 124 may apply the outputted displacements to the corresponding vertices in neutral target shape 204 to generate deformed target shape 206.

In a third example, machine learning model 208 may include a point-based neural network. Inputs 220 and 222 into the point-based neural network may include coordinates and/or other attributes of points in deformed template shape 202 and neutral target shape 204, and outputs 224 may include per-point displacements associated with neutral target shape 204. Execution engine 124 may apply these per-point displacements to the corresponding points in neutral target shape 204 to generate deformed target shape 206.

In a fourth example, machine learning model 208 may include neural network layers, modules, blocks, and/or other components that perform convolutions on meshes, graphs, and/or other types of inputs 220 and 222 that represent and/or characterize geometric surfaces on deformed template shape 202 and neutral target shape 204. Outputs 224 may include displacements and/or other representations of changes to the geometric surface of neutral target shape 204. These outputs 224 may be combined with a corresponding representation of the geometric surface of neutral target shape 204 to produce a representation of the geometric surface of deformed target shape 206.

In a fifth example, machine learning model 208 may include one or more MLPs. Inputs 220 and 222 into these MLPs may include coordinates of vertices in deformed template shape 202 and neutral target shape 204. The MLPs may convert these inputs 220 into corresponding outputs 224 that include displacements associated with vertices in neutral target shape 204, which are combined with the vertices in neutral target shape 204 to produce deformed target shape 206. Outputs 224 may also, or instead, include coordinates of vertices in deformed target shape 206, which can be used to generate a mesh and/or another 3D representation of deformed target shape 206.

Additionally, machine learning model 208 may be used to perform various tasks associated with deformed template shape 202, neutral target shape 204, and/or deformed target shape 206. For example, machine learning model 208 may be used to transfer a performance from the template subject to an arbitrary target subject with a corresponding neutral target shape 204. In another example, machine learning model 208 may be used to generate deformed target shape 206 as an initial or key pose, expression, and/or another deformation of a target subject. Deformed target shape 206 may then be modified (e.g., using a sculpting technique, a set of blendshapes for the target subject, etc.) to generate a sequence of deformed target shapes corresponding to an animation associated with the target subject, an edited version of deformed template shape 202 that corresponds to a slightly different expression on the target subject, and/or other variations of deformed target shape 206. In a third example, machine learning model 208 may be used to convert template blendshapes 240 and/or another set of blendshapes for the template subject into corresponding blendshapes for the target subject.

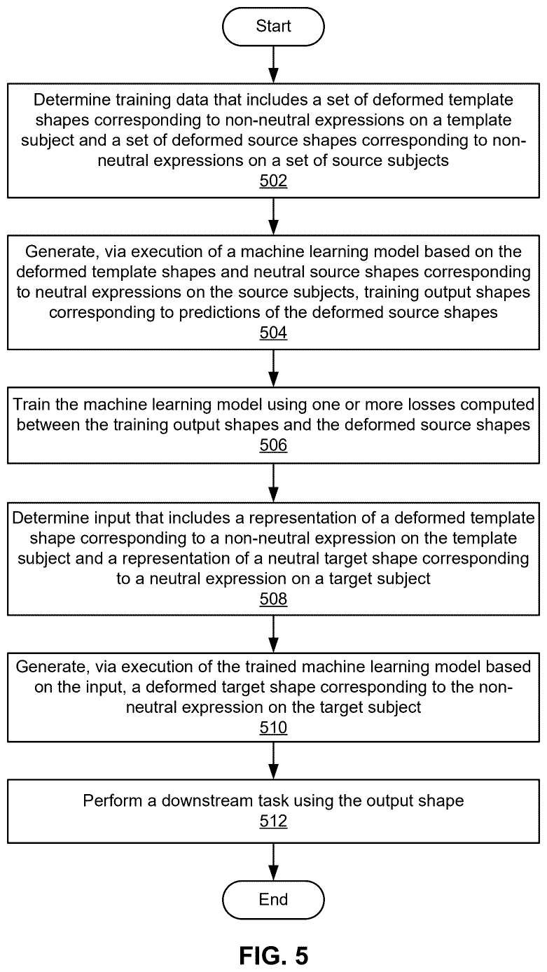

FIG. 5 is a flow diagram of method steps for performing neural shape deformation transfer, according to various embodiments. Although the method steps are described in conjunction with the systems of FIGS. 1-2, persons skilled in the art will understand that any system configured to perform the method steps in any order falls within the scope of the present disclosure.

As shown, in step 502, training engine 122 determines training data that includes a set of deformed template shapes corresponding to non-neutral expressions on a template subject and a set of deformed source shapes corresponding to non-neutral expressions on a set of source subjects. For example, training engine 122 may compute displacements between each deformed source shape and a neutral source shape that includes a neutral expression on the same source subject. Training engine 122 may transfer the displacements onto a neutral template shape corresponding to the neutral expression on the template subject to generate an initial deformed template shape. Training engine 122 may then generate an updated deformed template shape that includes the non-neutral expression from the deformed source shape and the identity of the template subject by solving for a linear combination of blendshapes for the template subject that most closely matches the initial deformed template shape. Training engine 122 may pair this updated deformed template shape with the corresponding deformed source shape.

In step 504, training engine 122 generates, via execution of a machine learning model based on the deformed template shapes and neutral source shapes associated with the source subjects, training output shapes corresponding to predictions of the deformed source shapes. For example, training engine 122 may input a given deformed template shape and a neutral source shape for a source subject into a transformer neural network, MLP, DiffusionNet neural network, point-based neural network, graph neural network, and/or another type of machine learning model that is capable of processing points, vertices, polygons, and/or other representations of surfaces on the deformed template shape and neutral source shape. Training engine 122 may use the machine learning model to generate a training output shape from the inputted shapes. Training engine 122 may repeat the process for a certain number of deformed template shapes and neutral source shapes in the training data, all deformed template shapes and neutral source shapes in the training data, and/or another set or batch of deformed template shapes and neutral source shapes in the training data.

In step 506, training engine 122 trains the machine learning model using one or more losses computed between the training output shapes and the deformed source shapes. For example, training engine 122 may compute the loss(es) as an MSE and/or another measure of error between each set of training output shapes and a corresponding set of ground truth deformed source shapes. Training engine 122 may additionally use a training technique (e.g., gradient descent and backpropagation) to iteratively update parameters of the machine learning model in a way that reduces the loss(es).

In step 508, execution engine 124 determines input that includes a representation of a deformed template shape corresponding to a non-neutral expression on the template subject and a representation of a neutral target shape corresponding to a neutral expression on a target subject. For example, execution engine 124 may determine the neutral target shape and/or deformed template shape as a combination of blendshapes for the corresponding subject(s), one or more 3D shapes captured using a scanning technique and/or generated via a sculpting technique, and/or via other methods. Execution engine 124 may generate the input as a collection and/or ordering of points and/or vertices in the neutral target shape and deformed template shape; position-encoded tokens representing the points and/or vertices; geometric properties associated with the surfaces of the neutral target shape and deformed template shape; and/or other representations of the neutral target shape and deformed template shape.

In step 510, execution engine 124 generates, via execution of the trained machine learning model based on the input, a deformed target shape corresponding to the non-neutral expression on the target subject. For example, execution engine 124 may obtain, as output of the machine learning model, displacements associated with vertices and/or points in the neutral target shape, coordinates and/or positions of the vertices and/or points in the deformed target shape, and/or another representation of vertices, points, and/or surfaces in the deformed target shape. Execution engine 124 may use the output to generate a mesh, point cloud, and/or another representation of the deformed target shape.

In step 512, execution engine 124 performs a downstream task using the deformed target shape. For example, execution engine 124 may use the deformed target shape to transfer a performance from the template subject to the target subject, generate an animation of the target subject, and/or generate one or more new deformed target shapes corresponding to one or more additional deformations of the target subject.

In sum, the disclosed techniques train and execute a machine learning model to perform neural shape deformation transfer, in which the deformation of a template subject relative to a neutral shape for the same template subject is transferred to a target subject in a manner that is consistent with the identity of the target subject. For example, the machine learning model may be used to transfer deformations associated with a deformed template shape corresponding to a non-neutral expression on a template face (or another type of deformable object associated with a first identity) onto a neutral target shape corresponding to a neutral expression on a target face (or another type of deformable object associated with a second identity). Output of the machine learning model may be used to generate a deformed target shape that includes a facial deformation that is unique to the identity of the target face and semantically matches the non-neutral expression on the template face.

Training data for the machine learning model includes neutral source shapes corresponding to a neutral expression on a set of source subjects, deformed source shapes corresponding to non-neutral expressions on the same source subjects, and deformed template shapes corresponding to non-neutral expressions on the template subject. The deformed template shapes may be generated by computing displacements between each deformed source shape and a neutral source shape for the same source subject, transferring the displacements to a neutral template shape corresponding to the neutral expression on the template subject to generate an initial deformed template shape, and computing an updated deformed template shape as a linear combination of blendshapes for the template subject that best matches the initial deformed template shape. Each deformed template shape is paired with a corresponding deformed source shape, and the machine learning model is trained to predict the deformed template shape based on input that includes the deformed source shape and the neutral source shape for the same source subject.

The trained machine learning model can then be used to generate a deformed target shape that includes the identity of a target subject represented by a neutral target shape and an expression associated with a deformed template shape for the template subject. For example, vertices, points, tokens, geometric properties, and/or other representations of the deformed target shape and neutral target shape may be inputted into the trained machine learning model. The inputted data may be processed by various layers, blocks, modules, and/or other components in the trained machine learning model to generate additional vertices, points, tokens, geometric properties, displacements, and/or other output associated with the deformed target shape. The output may be used to generate a representation of the deformed target shape, and the deformed target shape may be used to perform performance retargeting, shape editing, animation, blendshape generation, and/or other types of downstream task.

One technical advantage of the disclosed techniques relative to the prior art is the ability to generate blendshapes for a new target subject from an existing set of blendshapes for a template subject. Consequently, the disclosed techniques may consume less time and/or fewer resources than traditional blendshape generation approaches that involve scanning a target subject and/or manually sculpting 3D meshes corresponding to different expressions of the target subject. Another technical advantage of the disclosed techniques is the ability to transfer deformations from the template subject to the target subject without requiring a predefined blendshape basis and/or set of blendweights for the template subject. The disclosed techniques can thus improve the quality of the generated blendshapes over geometry-based techniques that do not account for deformations that are unique to individuals and/or data-driven techniques that train neural networks to generate blendshapes using identity-specific blendweights. The disclosed techniques additionally allow the generated blendshapes to generalize to expressions that are not included in a predefined blendshape basis and/or blendshape systems that include different numbers and/or types of blendshapes without requiring retraining of the machine learning model. These technical advantages provide one or more technological improvements over prior art approaches.
1. In some embodiments, a computer-implemented method for generating a shape comprises determining (i) a deformed template shape corresponding to a non-neutral expression on a template subject and (ii) a neutral target shape corresponding to a neutral expression on a target subject; generating input representing the deformed template shape and the neutral target shape; and generating, via execution of a machine learning model based on the input, a deformed target shape corresponding to the non-neutral expression on the target subject.
2. The computer-implemented method of clause 1, further comprising training the machine learning model based on one or more losses computed between the deformed target shape and a ground truth shape corresponding to the non-neutral expression on the target subject.
3. The computer-implemented method of any of clauses 1-2, further comprising computing a set of displacements between the neutral target shape and the ground truth shape; and generating the deformed template shape based on the set of displacements and a set of blendshapes associated with the template subject.
4. The computer-implemented method of any of clauses 1-3, wherein generating the deformed template shape comprises transferring the set of displacements to a neutral template shape corresponding to the neutral expression on the template subject to generate an initial deformed template shape; and generating the deformed template shape as a combination of the set of blendshapes that matches the initial deformed template shape.
5. The computer-implemented method of any of clauses 1-4, wherein the one or more losses comprise a mean squared error.
6. The computer-implemented method of any of clauses 1-5, wherein the machine learning model comprises a transformer neural network, and the input comprises a first set of tokens corresponding to a first set of vertices in the deformed template shape and a second set of tokens corresponding to a second set of vertices in the neutral target shape.
7. The computer-implemented method of any of clauses 1-6, wherein the machine learning model comprises a spatial diffusion layer, a set of spatial gradient features, and a multilayer perceptron, and the input comprises a first set of geometric properties associated with the deformed template shape and a second set of geometric properties associated with the neutral target shape.
8. The computer-implemented method of any of clauses 1-7, wherein the input comprises a first set of points in the deformed template shape and a second set of points in the neutral target shape, and the machine learning model generates a set of displacements associated with the second set of points.
9. The computer-implemented method of any of clauses 1-8, wherein the deformed template shape is determined via at least one of a scanning technique or a sculpting technique.
10. The computer-implemented method of any of clauses 1-9, wherein the template subject comprises a first face and the target subject comprises a second face.
11. In some embodiments, one or more non-transitory computer-readable media store instructions that, when executed by one or more processors, cause the one or more processors to perform the steps of determining (i) a deformed template shape corresponding to a first non-neutral expression on a template subject and (ii) a neutral target shape corresponding to a neutral expression on a target subject; generating input representing the deformed template shape and the neutral target shape; and generating, via execution of a trained machine learning model based on the input, a deformed target shape corresponding to the first non-neutral expression on the target subject.
12. The one or more non-transitory computer-readable media of clause 11, wherein the instructions further cause the one or more processors to perform the steps of generating a plurality of deformed template shapes associated with the template subject based on (i) a plurality of neutral source shapes associated with a plurality of source subjects and (ii) a plurality of deformed source shapes associated with the plurality of source subjects; generating, via execution of a machine learning model, a plurality of training output shapes based on the plurality of deformed template shapes and the plurality of neutral source shapes; and training the machine learning model based on one or more losses computed between the plurality of training output shapes and the plurality of deformed source shapes to generate the trained machine learning model.
13. The one or more non-transitory computer-readable media of any of clauses 11-12, wherein generating the plurality of deformed template shapes comprises computing a set of displacements between a neutral source shape included in the plurality of neutral source shapes and a deformed source shape included in the plurality of deformed source shapes; transferring the set of displacements to a neutral template shape corresponding to the neutral expression on the template subject to generate an initial deformed template shape; and generating a deformed template shape included in the plurality of deformed template shapes as a combination of a set of blendshapes for the template subject that matches the initial deformed template shape.
14. The one or more non-transitory computer-readable media of any of clauses 11-13, wherein the neutral source shape corresponds to a neutral expression on a source subject included in the plurality of source subjects and the deformed source shape corresponds to a second non-neutral expression on the source subject.
15. The one or more non-transitory computer-readable media of any of clauses 11-14, wherein the template subject and the plurality of source subjects comprise a plurality of faces.
16. The one or more non-transitory computer-readable media of any of clauses 11-15, wherein the trained machine learning model comprises a transformer neural network, and the input comprises a first set of tokens corresponding to a first set of vertices in the deformed template shape and a second set of tokens corresponding to a second set of vertices in the neutral target shape.
17. The one or more non-transitory computer-readable media of any of clauses 11-16, wherein the trained machine learning model comprises a spatial diffusion layer, a set of spatial gradient features, and a multilayer perceptron, and the input comprises a first set of geometric properties associated with the deformed template shape and a second set of geometric properties associated with the neutral target shape.
18. The one or more non-transitory computer-readable media of any of clauses 11-17, wherein the instructions further cause the one or more processors to perform the step of generating at least one of an animation, an edited version of the deformed target shape, or a set of blendshapes for the target subject based on the deformed target shape.
19. The one or more non-transitory computer-readable media of any of clauses 11-18, wherein the neutral target shape is determined via at least one of a scanning technique or a sculpting technique.
20. In some embodiments, a system comprises one or more memories that store instructions, and one or more processors that are coupled to the one or more memories and, when executing the instructions, are configured to perform the steps of determining (i) a deformed template shape corresponding to a non-neutral expression on a template subject and (ii) a neutral target shape corresponding to a neutral expression on a target subject; generating input representing the deformed template shape and the neutral target shape; and generating, via execution of a machine learning model based on the input, a deformed target shape corresponding to the non-neutral expression on the target subject.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a shape, the method comprising:
determining (i) a deformed template shape corresponding to a non-neutral expression on a template subject and (ii) a neutral target shape corresponding to a neutral expression on a target subject;
generating input representing the deformed template shape and the neutral target shape; and
generating, via execution of a machine learning model based on the input, a deformed target shape corresponding to the non-neutral expression on the target subject.

2. The computer-implemented method of claim 1, further comprising training the machine learning model based on one or more losses computed between the deformed target shape and a ground truth shape corresponding to the non-neutral expression on the target subject.

3. The computer-implemented method of claim 2, further comprising:
computing a set of displacements between the neutral target shape and the ground truth shape; and
generating the deformed template shape based on the set of displacements and a set of blendshapes associated with the template subject.

4. The computer-implemented method of claim 3, wherein generating the deformed template shape comprises:
transferring the set of displacements to a neutral template shape corresponding to the neutral expression on the template subject to generate an initial deformed template shape; and
generating the deformed template shape as a combination of the set of blendshapes that matches the initial deformed template shape.

5. The computer-implemented method of claim 2, wherein the one or more losses comprise a mean squared error.

6. The computer-implemented method of claim 1, wherein:
the machine learning model comprises a transformer neural network, and
the input comprises a first set of tokens corresponding to a first set of vertices in the deformed template shape and a second set of tokens corresponding to a second set of vertices in the neutral target shape.

7. The computer-implemented method of claim 1, wherein:
the machine learning model comprises a spatial diffusion layer, a set of spatial gradient features, and a multilayer perceptron, and
the input comprises a first set of geometric properties associated with the deformed template shape and a second set of geometric properties associated with the neutral target shape.

8. The computer-implemented method of claim 1, wherein:
the input comprises a first set of points in the deformed template shape and a second set of points in the neutral target shape, and
the machine learning model generates a set of displacements associated with the second set of points.

9. The computer-implemented method of claim 1, wherein the deformed template shape is determined via at least one of a scanning technique or a sculpting technique.

10. The computer-implemented method of claim 1, wherein the template subject comprises a first face and the target subject comprises a second face.

11. One or more non-transitory computer-readable media storing instructions that, when executed by one or more processors, cause the one or more processors to perform the steps of:
determining (i) a deformed template shape corresponding to a first non-neutral expression on a template subject and (ii) a neutral target shape corresponding to a neutral expression on a target subject;
generating input representing the deformed template shape and the neutral target shape; and
generating, via execution of a trained machine learning model based on the input, a deformed target shape corresponding to the first non-neutral expression on the target subject.

12. The one or more non-transitory computer-readable media of claim 11, wherein the instructions further cause the one or more processors to perform the steps of:
generating a plurality of deformed template shapes associated with the template subject based on (i) a plurality of neutral source shapes associated with a plurality of source subjects and (ii) a plurality of deformed source shapes associated with the plurality of source subjects;
generating, via execution of a machine learning model, a plurality of training output shapes based on the plurality of deformed template shapes and the plurality of neutral source shapes; and
training the machine learning model based on one or more losses computed between the plurality of training output shapes and the plurality of deformed source shapes to generate the trained machine learning model.

13. The one or more non-transitory computer-readable media of claim 12, wherein generating the plurality of deformed template shapes comprises:
computing a set of displacements between a neutral source shape included in the plurality of neutral source shapes and a deformed source shape included in the plurality of deformed source shapes;
transferring the set of displacements to a neutral template shape corresponding to the neutral expression on the template subject to generate an initial deformed template shape; and
generating a deformed template shape included in the plurality of deformed template shapes as a combination of a set of blendshapes for the template subject that matches the initial deformed template shape.

14. The one or more non-transitory computer-readable media of claim 13, wherein the neutral source shape corresponds to a neutral expression on a source subject included in the plurality of source subjects and the deformed source shape corresponds to a second non-neutral expression on the source subject.

15. The one or more non-transitory computer-readable media of claim 12, wherein the template subject and the plurality of source subjects comprise a plurality of faces.

16. The one or more non-transitory computer-readable media of claim 11, wherein:
the trained machine learning model comprises a transformer neural network, and
the input comprises a first set of tokens corresponding to a first set of vertices in the deformed template shape and a second set of tokens corresponding to a second set of vertices in the neutral target shape.

17. The one or more non-transitory computer-readable media of claim 11, wherein:
the trained machine learning model comprises a spatial diffusion layer, a set of spatial gradient features, and a multilayer perceptron, and
the input comprises a first set of geometric properties associated with the deformed template shape and a second set of geometric properties associated with the neutral target shape.

18. The one or more non-transitory computer-readable media of claim 11, wherein the instructions further cause the one or more processors to perform the step of generating at least one of an animation, an edited version of the deformed target shape, or a set of blendshapes for the target subject based on the deformed target shape.

19. The one or more non-transitory computer-readable media of claim 11, wherein the neutral target shape is determined via at least one of a scanning technique or a sculpting technique.

20. A system, comprising:
one or more memories that store instructions, and
one or more processors that are coupled to the one or more memories and, when executing the instructions, are configured to perform the steps of:
determining (i) a deformed template shape corresponding to a non-neutral expression on a template subject and (ii) a neutral target shape corresponding to a neutral expression on a target subject;
generating input representing the deformed template shape and the neutral target shape; and
generating, via execution of a machine learning model based on the input, a deformed target shape corresponding to the non-neutral expression on the target subject.
